(19) United States
(12) Patent Application Publication
(10) Pub. No.: US 2008/0260024 A1
(43) Pub. Date: Oct. 23, 2008

(54) METHOD, DEVICE, INTEGRATED CIRCUIT, AND TRANSCODER FOR SELECTIVELY REDUCING QUANTIZATION LEVELS

(75) Inventors: Wei-Fu CHEN, Taipei (TW); Hon-Wen PON, Taipei (TW); Ju-Yun CHENG, Taipei (TW); Takeshi TANAKA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/865,845

(22) Filed: Oct. 2, 2007

(30) Foreign Application Priority Data
Oct. 3, 2006 (JP) 2006-271963

(51) Int. Cl. H04N 7/26

(52) U.S. Cl. 375/240.03; 375/240.23; 375/E07.198

(57) ABSTRACT

A method for selectively reducing quantization levels is adapted for use in a transcoder including a variable length decoding unit. The variable length decoding unit decodes a plurality of input variable length codes into a plurality of decoded pairs, wherein each decoded pair is a run-level pair. The method includes the following steps: (a) obtaining a plurality of absolute levels arranged in an order of scan positions according to the runs and levels of the decoded pairs; (b) determining whether a saved bit number correspondingly found by reducing each absolute level exceeds a bit number threshold value such that, if yes, the respective absolute level belongs to a target set; and (c) reducing each absolute level that belongs to the target set.

### BACKGROUND OF THE INVENTION

1. Field of Invention

The invention relates to a method, device, integrated circuit, and transcoder for reducing bit rate, and more particularly to a method, device, integrated circuit, and transcoder for selectively reducing quantization levels so as to reduce bit rate.

2. Description of Related Art

Recently, with the popularity of transmitting multimedia data over networks, it is often necessary to transcode a pre-compressed and encoded video bit stream into another video bit stream suited for network channels of different bandwidth. In actual applications, the moving picture experts group (hereinafter referred to as MPEG) is a very common coding standard. Based on the MPEG coding standard, most pre-compressed and encoded video bit streams are usually encoded at a very high bit rate so as to ensure high quality video signals. However, the cost of transmitting video bit streams with such a high bit rate is very expensive and usually a general network channel cannot provide a sufficient bandwidth for that. Therefore, it is necessary to transcode the pre-coded video bit stream into a video bit stream with a lower bit rate.

U.S. Patent Application Publication No. 2004/0062313 discloses a transcoder. The transcoder includes a variable length decoder (VLD), a rate controller including a thresholder, and a variable length encoder (VLE). The transcoder is used to receive an input bit stream that was compressed according to the MPEG coding standard, where the input bit stream first passes through the VLD for being decoded into a plurality of decoded pairs, and then with the assistance of the rate controller, the decoded pairs pass through the VLE to obtain a final output bit stream with a lower bit rate. Each decoded pair has a number describing consecutive zero coefficients (referred to as run hereinafter), and a non-zero coefficient quantization level (also referred to as level only hereinafter). If a predetermined determination condition is matched, the decoded pairs will be directed to the processing of the thresholder.

Referring to FIG. 1, the thresholder of the rate controller obtains a plurality of absolute levels (also referred to as levels only) arranged in an order of scan positions according to the runs and levels of the decoded pairs. A high frequency portion that is at a higher scan position is divided using scan indices that are labeled as I(0), I(1), and I(2) into three partitions, which are a first partition from I(0) to I(1), a second partition from I(1) to I(2), and a third partition higher than I(2). Each partition is assigned a threshold value, i.e., the first partition has a threshold value of L(0), the second partition has a threshold value of L(1), and the third partition has a threshold value of L(2). If an absolute level falling within a certain partition is smaller than the threshold value of that particular partition, the absolute level is set to 0. Otherwise, the original absolute level is preserved. For example, if an absolute level falling within the first partition is smaller than L(0), the absolute level is set to 0. Otherwise, the original absolute level is preserved.

After processed by the thresholder, many absolute levels falling within the high frequency portion will be set to 0, which indeed reduces the bit rate of the output bit stream. However, under some relatively extreme circumstances, it is possible that the absolute levels in the high frequency portion are all set to zero, where the picture may lose all the high frequency details and thus become blurred as a whole, resulting in the quality of the picture being considerably reduced. Therefore, the aforesaid conventional method and technique apparently have room for improvement.

### SUMMARY OF THE INVENTION

Therefore, the main object of the present invention is to provide a method for selectively reducing levels.

Accordingly, the method for selectively reducing levels of the present invention processes a plurality of decoded pairs, wherein each decoded pair represents a run-level pair. The method includes: (a) obtaining a plurality of levels arranged in an order of scan positions according to the runs and levels; (b) determining whether a saved bit number correspondingly found by reducing each level exceeds a bit number threshold value such that, if yes, the respective level belongs to a target set; and (c) reducing each level that belongs to the target set.

Another object of the present invention is to provide a device operable to selectively reduce levels.

Accordingly, the device operable to selectively reduce levels of the present invention processes a plurality of decoded pairs, wherein each decoded pair represents a run-level pair. The device includes a determining unit and a level reducing unit. The determining unit includes a level selecting module. The determining unit is used to initially obtain a plurality of levels that are arranged in an order of scan positions according to the runs and levels, and subsequently uses the level selecting module to determine whether a saved bit number correspondingly found by reducing each level exceeds a bit number threshold value such that, if yes, the respective level is deemed to belong to a target set. The level reducing unit is used for reducing each level belonging to the target set.

Still another object of the present invention is to provide an integrated circuit operable to selectively reduce levels.

Accordingly, the integrated circuit operable to selectively reduce levels of the present invention processes a plurality of decoded pairs, wherein each decoded pair is a run-level pair. The integrated circuit is made of a semiconductor chip, and includes a determining unit and a level reducing unit. The determining unit includes a level selecting module. The determining unit is used to initially obtain a plurality of levels that are arranged in an order of scan positions according to the runs and levels, and subsequently uses the level selecting module to determine whether a saved bit number correspondingly found by reducing each level exceeds a bit number threshold value such that, if yes, the respective level is deemed to belong to a target set. The level reducing unit is used for reducing each level belonging to the target set.

Yet another object of the present invention is to provide a transcoder operable to selectively reduce levels.

Accordingly, the transcoder operable to selectively reduce levels of the present invention processes a plurality of decoded pairs, wherein each decoded pair is a run-level pair. The transcoder converts an input bit stream into an output bit stream having a lower bit rate. The input bit stream includes a plurality of input variable length codes and the output bit stream includes a plurality of output variable length codes.

The transcoder includes a variable length decoding unit, a re-quantization unit, a device operable to selectively reduce levels, a decision unit, and a variable length encoding unit. The variable length decoding unit is used to receive the input variable length codes in a predetermined block and to decode the same into a plurality of the decoded pairs. The re-quantization unit is used to perform re-quantization according to the decoded pairs. The device includes a determining unit and a level reducing unit. The decision unit is used to decide whether the decoded pairs are to be directed to the processing of the re-quantization unit or the device. The variable length encoding unit is used to receive the decoded pairs that were processed by the re-quantization unit or the device, and to re-encode the same into the output variable length codes. The determining unit includes a level selecting module. The determining unit is used to initially obtain a plurality of levels that are arranged in an order of scan positions according to the runs and levels, and subsequently uses the level selecting module to determine whether a saved bit number correspondingly found by reducing each level exceeds a bit number threshold value such that, if yes, the respective level is deemed to belong to a target set. The level reducing unit is used for reducing each level belonging to the target set.

By selectively reducing the levels, the present invention is capable of reducing the bit rate of the output bit stream and maintaining picture quality, thereby achieving the objects of the present invention.

### BRIEF DESCRIPTION OF THE DRAWINGS

FIG. 1 is a graph illustrating the arrangement of absolute levels in an order of scan positions in the prior art.

FIG. 2 is a system block diagram illustrating a preferred embodiment of a transcoder according to the present invention.

FIG. 3 is a system block diagram illustrating a preferred embodiment of a device for selectively reducing quantization levels according to the present invention.

FIG. 4 is a flowchart illustrating a preferred embodiment of a method for selectively reducing quantization levels according to the present invention.

FIG. 5 is a schematic diagram illustrating a zigzag scan used in the present invention.

FIG. 6 is a graph illustrating an arrangement of absolute levels in an order of scan positions in the present invention.

FIG. 7A is a diagram illustrating an example of a variable length encoding table in the present invention.

FIG. 7B is a diagram illustrating an example of a variable length encoding table following FIG. 7A in the present invention.

FIG. 8A is a graph illustrating another arrangement of absolute levels in an order of scan positions in the present invention.

FIG. 8B is a graph illustrating yet another arrangement of absolute levels in an order of scan positions in the present invention.

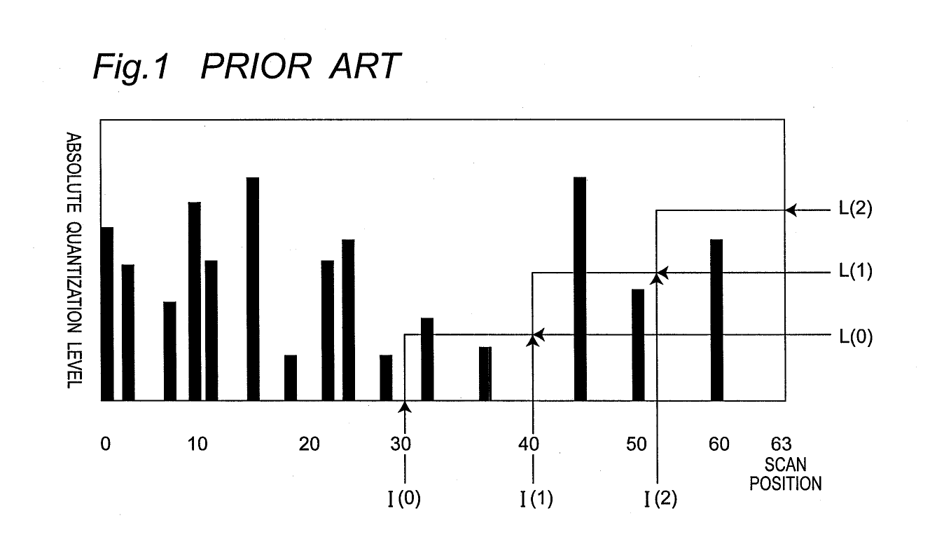

### DETAILED DESCRIPTION OF THE PREFERRED EMBODIMENTS

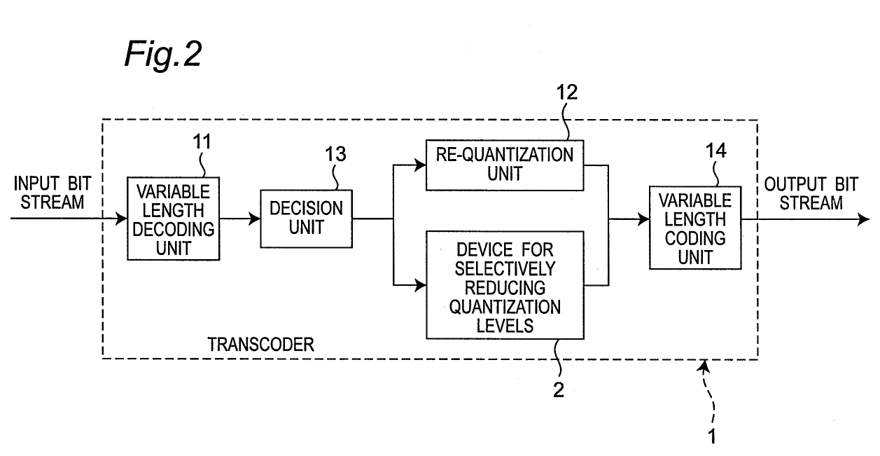

Referring to FIG. 2, the preferred embodiment of a transcoder according to the present invention is adapted to convert an input bit stream into an output bit stream with a lower bit rate. The input bit stream includes a plurality of input variable length codes. The output bit stream includes a plurality of output variable length codes. In this preferred embodiment, the input/output bit stream is compressed according to the MPEG coding standard.

The transcoder 1 includes a variable length decoding unit 11, a re-quantization unit 12, a device 2 for selectively reducing quantization levels, a decision unit 13, and a variable length coding unit 14.

First, the variable length decoding unit 11 receives the input variable length codes, and decodes the same into a plurality of decoded pairs, wherein each of the decoded pairs is a run-level pair having a number describing consecutive zero coefficients (hereinafter referred to as run) and a non-zero coefficient quantization level (hereinafter also referred to as level only).

Subsequently, the decision unit 13 determines whether a compression ratio when transcoding up to a current macroblock is greater than a compression ratio threshold value. If yes, the decoded pairs of the current macroblock are selectively directed to the processing of the device 2 for selectively reducing quantization levels. Otherwise, they are directed to the processing of the re-quantization unit 12.

The definition of the compression ratio is: a bit number expected to be produced divided by the actually produced bit number up to the current macroblock. For example, if the bit number expected to be produced is 1 KB, and the actually produced bit number is 2 KB, the compression ratio is 0.5. Therefore, under normal circumstances, a larger compression ratio represents a better compression condition. Conversely, the compression condition does not meet expectations. When the compression ratio is too high (i.e., the compression ratio is greater than the compression ratio threshold value), it is necessary to select the processing of the device 2 for selectively reducing the quantization levels so as to prevent reduction in picture quality.

Finally, the variable length encoding unit 14 receives the decoded pairs that were directed to the processing of the re-quantization unit 12 or the device 2 for selectively reducing quantization levels, and re-encodes the same into the output variable length codes. The re-quantization unit 12 performs re-quantization according to the decoded pairs. The re-quantization unit 12 specifically performs inverse quantization for the decoded pairs and performs second quantization with different quantized coefficients. The processing of the device 2 for selectively reducing quantization levels is further described as follows.

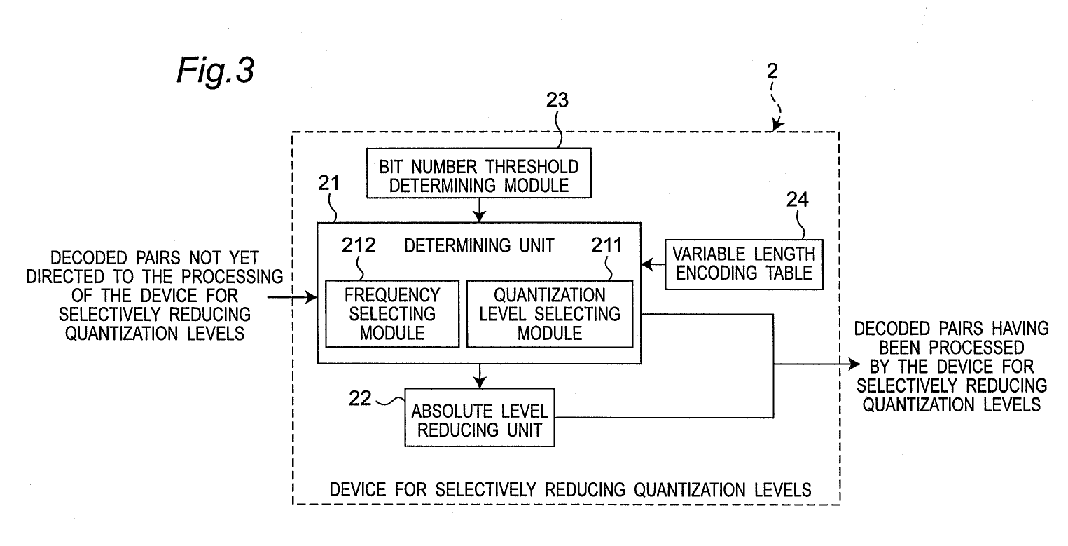

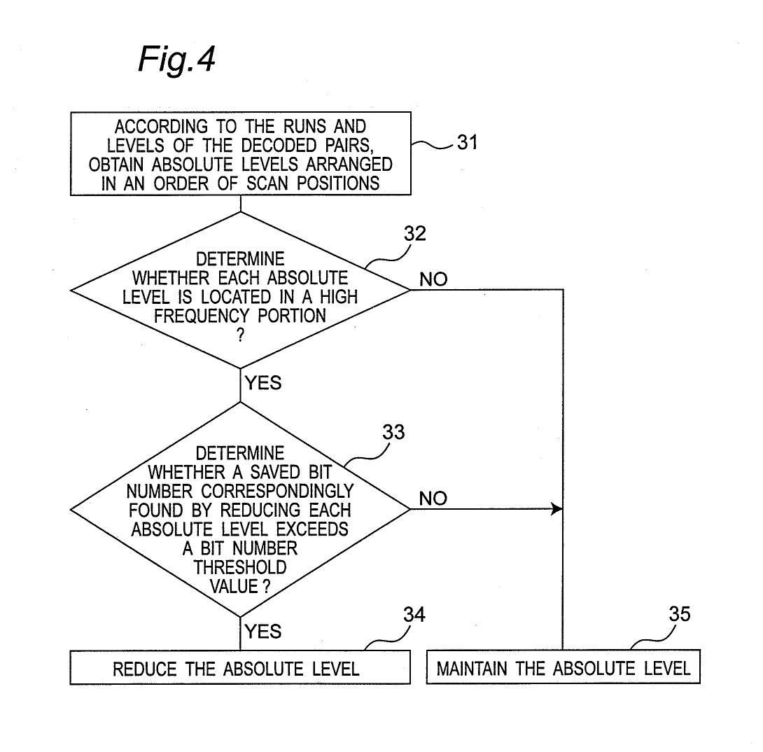

Referring to FIG. 3 and FIG. 4, the device 2 for selectively reducing quantization levels includes a determining unit 21, an absolute level reducing unit 22 (also referred to as level reducing unit), a bit number threshold determining module 23, and a variable length encoding table 24. The determining unit 21 has a quantization level selecting module 211 (also referred to as level selecting module) and a frequency selecting module 212.

In step 31, according to the runs and levels of the decoded pairs, the determining unit 21 obtains a plurality of absolute levels that are arranged in an order of scan positions. The scan positions are arranged in an ascending order according to the frequency values to which the absolute levels correspond. The absolute level is described as the level of the decoded pairs denoting the runs and levels. The absolute level is also referred to as an absolute quantization level.

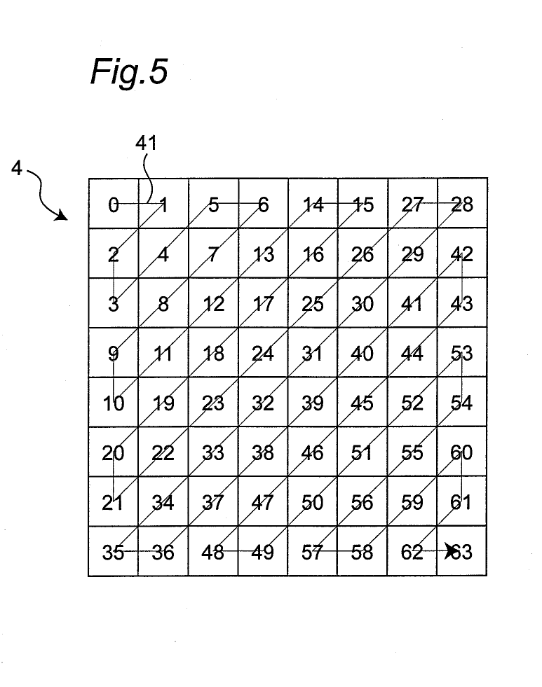

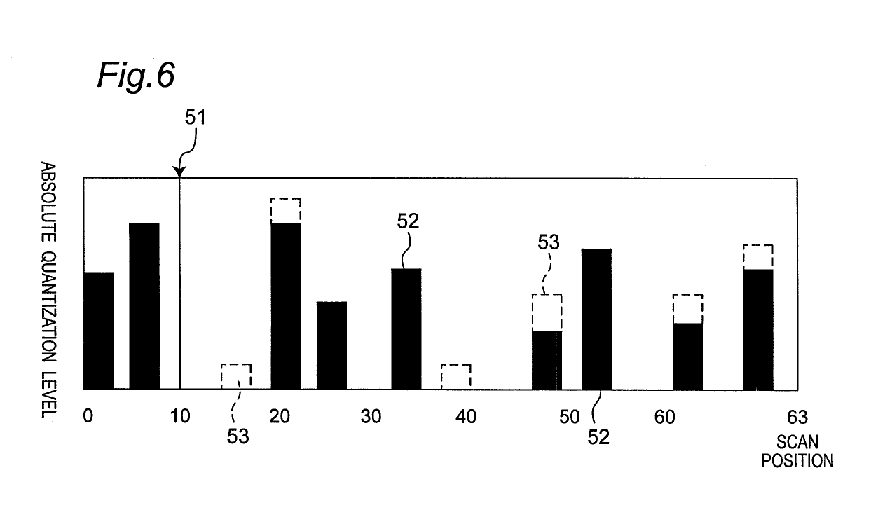

As shown in FIG. 5, the absolute levels thus found can be expressed in units of blocks 4. The order of arrangement of the absolute levels is based on the order of zigzag scan 41 in the MPEG, with 0-63 scan positions arranged in order. With the size of the absolute levels as a Y-axis, and with the order of the zigzag scan 41 as an X-axis, a graph as shown in FIG. 6 can be obtained, in which the larger the X-axis coordinate is, the higher the frequency value will be to which it corresponds.

Referring to FIG. 3, FIG. 4 and FIG. 6, in step 32, the frequency selecting module 212 of the determining unit 21 determines whether the frequency value to which each absolute level corresponds is greater than a frequency threshold value 51. If yes, the flow goes on to step 33. Otherwise, as shown in step 35, the respective absolute level and is maintained and remains unchanged.

In step 33, the quantization level selecting module 211 of the determining unit 21 determines whether a saved bit number correspondingly found by reducing each absolute level exceeds a bit number threshold value. If yes, the absolute level belongs to a target set. Otherwise, as shown in step 35, the absolute level is preserved and remains unchanged.

The bit number threshold value determining module 23 multiplies the bit number of the input variable length codes by a predetermined ratio so as to obtain the bit number threshold value. The saved bit number is defined as: with reference to the variable length encoding table 24, a reference variable length code is found using the decoded pair that is correspondingly changed after reducing the absolute level, and the number of bits that is saved by the reference variable length code with respect to the input variable length code is the saved bit number. For example, suppose each decoded pair can be expressed as (run, level). If the decoded pair decoded from the input variable length code is (3, 3), a required encoding bit number of 13 can be obtained with reference to the variable length encoding table 24, i.e., the bit number of the input variable length code is 13. The decoded pair that is correspondingly changed after reducing the absolute level is (3, 2), and the required encoding bit number obtained with reference to the variable length encoding table 24 is 9. In other words, the bit number of the reference variable length code is 9, and the saved bit number is 4.

In step 34, the absolute level reducing unit 22 subtracts a predetermined value from each of the absolute levels belonging to the target set. In this preferred embodiment, the predetermined value is 1. The absolute levels of the target set after being directed to the processing in step 34 are shown in FIG. 6 as 53. The absolute levels that remain unchanged are shown in FIG. 6 as 52.

In addition, an integrated circuit for selectively reducing quantization levels includes the determining unit 21 and the absolute level reducing unit 22 shown in FIG. 3. The integrated circuit also includes at least one of the bit number threshold value determining module 23 and the variable length encoding table 24.

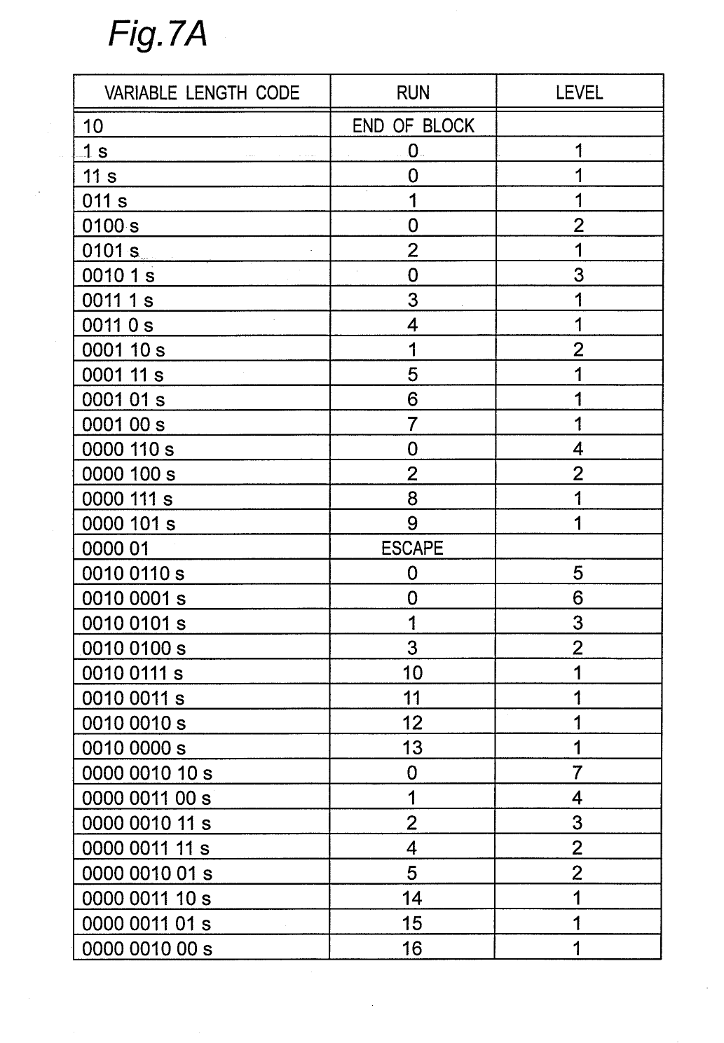

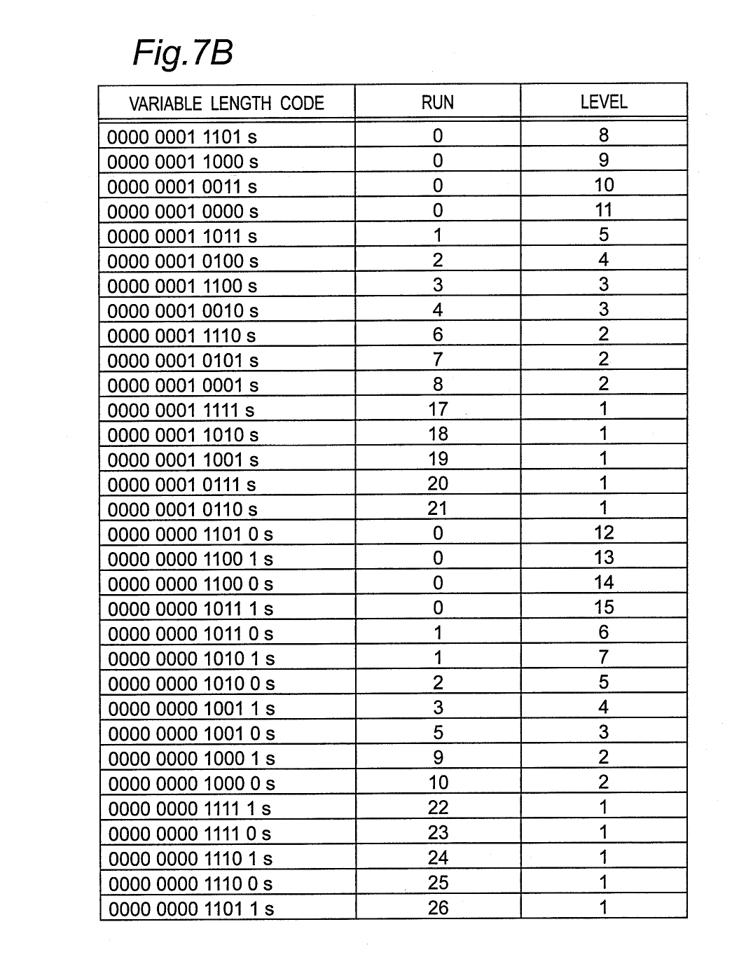

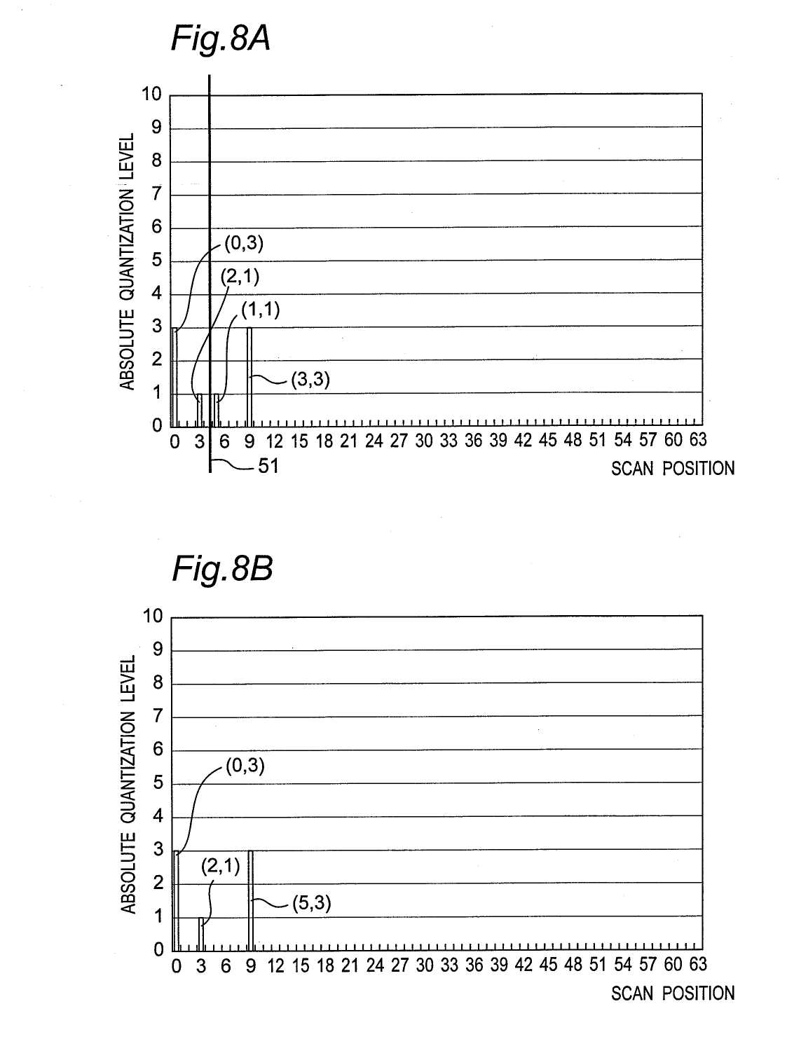

Here a brief example is given to explain FIGS. 7A and 7B showing an example of the variable length encoding table 24 and FIGS. 8A and 8B showing arrangement of absolute levels in an order of scan positions more clearly. The each value for performing is supposed as following: the predetermined ratio for the bit number threshold value determining module 23 is 0.4; the frequency threshold value 51 for the frequency selecting module 212 is 4; the decoded pairs decoded from the input variable length code are (0, 3), (2, 1), (1, 1), and (3, 3); the variable length encoding table 24 is the table of the MPEG2 encoding standard as shown in FIGS. 7A and 7B; and the predetermined subtraction value is 1.

Referring to FIG. 4, each step will be explained using above real value. In step 31 the absolute levels arranged in an order of scan positions will be obtained from the decoded pairs (0, 3), (2, 1), (1, 1), and (3, 3) as shown in FIG. 8A. The decoded pair (0, 3) shows the absolute level 3 at the scan position 0. The decoded pair (2, 1) shows the absolute level 1 at the scan position 3 following two runs. The decoded pair (1, 1) shows the absolute level 1 at the scan position 5 following one run. The decoded pair (3, 3) shows the absolute level 3 at the scan position 9 following three runs.

In step 32, according to the frequency threshold value, so the decoded pairs (0, 3) and (2, 1) will go to step 35 and the other decoded pairs (1, 1) and (3, 3) will go to step 33. In step 33, the decoded pairs (1, 1) and (3, 3) will be checked whether a saved bit number correspondingly found by reducing each absolute level exceeds a bit number threshold value. If yes, the absolute level belongs to a target set.

For the decoded pair (1, 1), the bit number of the input variable length code is 4 as shown in FIG. 7A. The predetermined value 1 is subtracted from the absolute level of the decoded pair (1, 1), resulting in the decoded pair (1, 0). Since the bit number of the output variable length code for the decoded pair (1, 0) is not required, the saved bit number is 4 (=4−0) after reducing the level. Furthermore, the bit number threshold value would be 1.6 (=4*0.4) using 4 of the bit number of the input variable length code and 0.4 of the predetermined ratio. Because the saved bit number 4 exceeds a bit number threshold value 1.6 (4>1.6), the decoded pair (1, 1) will belong to a target set.

For the decoded pair (3, 3), the bit number of the input variable length code is 13. The predetermined value 1 is subtracted from the absolute level of the decoded pair (3, 3), resulting in the decoded pair (3, 2). Since the bit number of the input variable length code for the decoded (3, 2) is 9, the saved bit number is 4 (=13−9). Furthermore, the bit number threshold value would be 5.2 (=13*0.4) using 13 of the bit number of the input variable length code and 0.4 of the predetermined ratio. In this case, because the saved bit number 4 does not exceed the bit number threshold value 5.2, the decoded pair (3, 3) will be sent to step 35 of the FIG. 4.

After step 34 for target set and step 35 for other decoded pairs, the run information of the decoded pair (3, 3) are 5 (=(9−3)−1) with the run information of the decoded pair (1, 0) being added. The bit number of the input variable length code of the decoded pair (3, 3) is 14 and the bit number of the input variable length code of the decoded pair (5, 3) is 13, as shown in FIG. 7B. The bit number of the input variable length code is increased by more one bit (=14−13) on re-encoding the decoded pair (3, 3) to the decoded pair (5, 3). Thus, decoded pairs having been processed will become (0,3), (2,1), and (5, 3) as shown in FIG. 8B, and the total saved bit is 3 (=4-1).

To sum up, according to the characteristics of the MPEG coding standard, many level values can be reduced to 0 after being directed to the processing of the device 2 for selectively reducing quantization levels, and the compression efficiency can be considerably enhanced to reduce the bit rate of the output bit stream. Further, the distribution (e.g. FIG. 8B) of the absolute levels for the frequency value after the subtraction of the predetermined value is substantially similar to that (e.g. FIG. 8A) before the subtraction. Thus, there will not be a considerable drop in quality of the entire image, and problems, such as loss of picture details due to all the absolute levels of the high frequency portion being set to 0, are avoided. Thus, the objects of the present invention can be positively achieved.

It is noted that although the preferred embodiment of the present invention is described using a bit stream compressed according to the MPEG coding standard as an example, the present invention may also be used with coding standards having similar variable length encoding/decoding and similar scan order, such as JPEG, H.263 and H.264, and thus should not be limited to the preferred embodiment.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

The present invention can be used in a method, device, integrated circuit and transcoder for selectively reducing quantization levels.

What is claimed is:

1. A method for selectively reducing levels of a plurality of decoded pairs, each decoded pair representing a run-level pair, said method comprising:
(a) obtaining a plurality of levels arranged in an order of scan positions according to the runs and levels;
(b) determining whether a saved bit number correspondingly found by reducing each level exceeds a bit number threshold value such that, if yes, the respective level belongs to a target set; and
(c) reducing each level that belongs to the target set.

2. The method according to claim 1, wherein, in step (c), a predetermined value is subtracted from each level belonging to the target set.

3. The method according to claim 1, wherein, in step (a), the order of scan positions is an ascending order of frequency values to which the levels correspond.

4. The method according to claim 1, further comprising, between steps (a) and (b):
(d) determining whether the frequency value to which each level corresponds is greater than a frequency threshold value such that, if yes, the processing in step (b) is allowed to continue, and otherwise, the level remains unchanged.

5. The method according to claim 1, wherein, in step (b), the bit number threshold value is defined as a bit number of the input variable length code multiplied by a predetermined ratio.

6. The method according to claim 1, wherein, in step (b), the saved bit number is defined as: with reference to a predetermined variable length encoding table, a reference variable length code is found using the decoded pair that is correspondingly changed after reducing the level, and the number of bits saved by the reference variable length code with respect to the input variable length code is the saved bit number.

7. A device operable to selectively reduce levels of a plurality of decoded pairs, each decoded pair representing a run-level pair, said device comprising:
a determining unit including a level selecting module, said determining unit being used to initially obtain a plurality of levels that are arranged in an order of scan positions according to the runs and levels, and subsequently using the level selecting module to determine whether a saved bit number correspondingly found by reducing each level exceeds a bit number threshold value such that, if yes, the respective level is deemed to belong to a target set; and
a level reducing unit operable to reduce each level belonging to the target set.

8. The device according to claim 7, wherein said level reducing unit subtracts a predetermined value from each level belonging to the target set.

9. The device according to claim 7, wherein the order of scan positions is an ascending order of frequency values to which the levels correspond.

10. The device according to claim 7, wherein said determining unit further includes a frequency selecting module operable to determine whether the frequency value to which each level corresponds is greater than a frequency threshold value such that, if yes, the processing of said level selecting module is allowed to continue, and otherwise, the level remains unchanged.

11. The device according to claim 7, further comprising a bit number threshold value determining module operable to multiply the bit number of the input variable length code by a predetermined ratio so as to obtain the bit number threshold value.

12. The device according to claim 7, further comprising a predetermined variable length encoding table, and the saved bit number is defined as: with reference to said variable length encoding table, a reference variable length code is found using the decoded pair that is correspondingly changed after reducing the level, and the number of bits saved by the reference variable length code with respect to the input variable length code is the saved bit number.

13. An integrated circuit made of a semiconductor chip, operable to selectively reduce levels of a plurality of decoded pairs, each decoded pair representing a run-level pair, said integrated circuit comprising:
a determining unit including a level selecting module, said determining unit being used to initially obtain a plurality of levels that are arranged in an order of scan positions according to the runs and levels, and subsequently using said level selecting module to determine whether a saved bit number correspondingly found by reducing each level exceeds a bit number threshold value such that, if yes, the respective level is deemed to belong to a target set; and
a level reducing unit operable to reduce each level belonging to the target set.

14. The integrated circuit according to claim 13, further comprising a bit number threshold value determining module operable to multiply the bit number of the input variable length code by a predetermined ratio so as to obtain the bit number threshold value.

15. The integrated circuit according to claim 13, further comprising a predetermined variable length encoding table, and the saved bit number is defined as: with reference to said variable length encoding table, a reference variable length code is found using the decoded pair that is correspondingly changed after reducing the level, and the number of bits saved by the reference variable length code with respect to the input variable length code is the saved bit number.

16. A transcoder operable to selectively reduce levels of a plurality of decoded pairs, each decoded pair representing a run-level pair, said transcoder operable to convert an input bit stream into an output bit stream having a lower bit rate, the input bit stream including a plurality of input variable length codes, the output bit stream including a plurality of output variable length codes, said transcoder comprising:
a variable length decoding unit operable to receive the input variable length codes in a predetermined block and to decode the same into a plurality of the decoded pairs;
a re-quantization unit operable to perform re-quantization according to the decoded pairs;
a device operable to selectively reduce levels;
a decision unit operable to decide whether the decoded pairs are to be directed to the processing of said re-quantization unit or said device; and
a variable length encoding unit operable to receive the decoded pairs that were processed by said re-quantization unit or said device, and operable to re-encode the same into the output variable length codes, wherein said device comprises:
a determining unit including a level selecting module, said determining unit being used to initially obtain a plurality of levels that are arranged in an order of scan positions according to the runs and levels, and subsequently using the level selecting module to determine whether a saved bit number correspondingly found by reducing each level exceeds a bit number threshold value such that, if yes, the respective level is deemed to belong to a target set; and
a level reducing unit operable to reduce each level belonging to the target set.

17. The transcoder according to claim 16, wherein said decision unit determines whether a compression ratio when transcoding the input variable length codes up to the predetermined block is greater than a compression ratio threshold value such that, if yes, the decoded pairs are selectively directed to the processing of said device, and otherwise, are directed to the processing of said re-quantization unit.

18. The transcoder according to claim 16, wherein the compression ratio is defined as a bit number expected to be produced divided by the actually produced bit number up to the predetermined block.
